(19) United States
(12) Patent Application Publication
(10) Pub. No.: US 2006/0062189 A1
(43) Pub. Date: Mar. 23, 2006

(54) Wireless transceiver, circuit module, and method for setting channel access time

(75) Inventor: Shojiro Takeuchi, Tokyo (JP)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/946,930

(22) Filed: Sep. 21, 2004

(51) Int. Cl. H04Q 7/24

(52) U.S. Cl. 370/338; 370/412

(57) ABSTRACT

A method for calculating a channel access time necessary for ensuring a desired throughput for a wireless transceiver for performing channel access using priority queuing system, the method comprising: calculating a channel access time necessary for accomplishing a desired throughput with respect to the or each one of a plurality of data flows stored in a buffer corresponding to apriority queue; and setting as a common channel access time for transmitting the data flow associated with the priority queue the largest value of the calculated channel access times.

### FIELD OF THE INVENTION

This invention relates to a method for setting channel access time for a wireless communication.

### BACKGROUND OF THE INVENTION

Wireless LAN technology has become very popular in recent years because of its advantage in price and bandwidth. Nowadays, wireless LAN is mainly used for Internet access, but real-time applications like Voice over IP (VoIP) and video on demand (Vod) are identified as the next killer applications for wireless LAN. To support such new applications, the IEEE 802.11e working group is now discussing new 802.11 medium access control (MAC) layer protocol. The status of IEEE 802.11e is now draft 9, and the final version will be released within 2005.

The IEEE802.11e is a standard to support Quality of Service (QoS). An access point that supports the QoS facility specified in this standard is called QoS-enhanced access point (QAP). Whereas a station that implements the QoS facility specified in this standard is called QoS-enhanced station (QSTA).

IEEE802.11e defines a new channel access function called Hybrid Coordination Function (HCF) to support QoS in 802.11 networks. The HCF has two modes in operation, one is a contention-based channel access, called enhanced distributed channel access (EDCA), and the other is a controlled channel access, referred to as HCF controlled channel access (HCCA).

Both for EDCA and HCCA, the transmission opportunity (TXOP) is the very important concept. The TXOP is an interval of time when a particular QSTA has the right to initiate frame exchange sequences onto the wireless medium. A TXOP is defined by a starting time and a maximum duration. In EDCA, the TXOP is obtained by the QSTA by successfully contending for the channel, whereas in DCCA it is assigned by the Hybrid Controller (HC).

For EDCA, the access category (AC) is also very important concept. The AC is a label for the common set of EDCA parameters that are used by a QSTA to contend for the channel in order to transmit MAC service data units (MSDUs) with certain priorities. IEEE802.11e defines 4 ACs, Voice, Video, Best Effort, and Background. Voice has the highest priority, Video is the second, Best Effort is the third, and Background has the lowest priority.

A QSTA that win contention to the wireless medium will obtain TXOP, and can start transmission of frames. TXOP can be obtained continuously. However, the maximum duration for which a QSTA can transmit after obtaining the first TXOP is limited. This duration is specified in TXOP Limit value. The TXOP limit values are advertised by the QAP in the EDCA Parameter Set Information Element in Beacons and Probe Response frames transmitted by the QAP.

The QAP needs to select an appropriate TXOP Limit value. However, the selection method is not specified in IEEE 802.11e standard. Thus it is expected to find an intelligent way to select the appropriate TXOP Limit value.

### SUMMARY OF THE INVENTION

According to the first aspect of the present invention, there is provided a wireless transceiver having a channel access function using priority queuing, wherein calculating a channel access time necessary for accomplishing a desired throughput with respect to the or each one of a plurality of data flows stored in a buffer corresponding to a priority queue, and setting as a common channel access time for transmitting the data flow associated with the priority queue the largest value of the calculated channel access times.

Hereby a preferable channel access time can be obtained for data flows in each priority queue, which results the effective use of the wireless medium.

The wireless transceiver provided by the first aspect of the present invention may perform the channel access based on a contention-based channel access. Preferably it calculates the channel access time for each one of the plurality of data flows having different destinations and/or applications each other. Preferably it transmits the common channel access time to another wireless transceiver for wirelessly communicating with the wireless transceiver in order to allow the another wireless transceiver to comply with the common channel access time. Preferably it calculates the common channel access time with respect to the priority queue specified by another wireless transceiver for wirelessly communicating with the wireless transceiver. A value of the desired throughput may be specified by the another wireless transceiver.

The wireless transceiver provided by the first aspect of the present invention may re-calculate the common channel access time at predetermined time intervals. It may comprise an access point for a wireless area network that complies with IEEE 802.11 and/or a derivative standard thereof. It may incorporate the priority queuing into the channel access function for medium access control layer.

According to the second aspect of the present invention, there is provided a circuit module for a medium access control (MAC) layer having a channel access function using a priority queuing, wherein calculating a channel access time necessary for accomplishing a desired throughput with respect to the or each one of a plurality of data flows stored in a buffer corresponding to a priority queue, and setting as a common channel access time for transmitting the data flow associated with the priority queue the largest value of the calculated channel access times.

According to the third aspect of the present invention, there is provided a method for calculating a channel access time necessary for ensuring a desired throughput for a wireless transceiver for performing channel access using priority queuing system, the method comprising: calculating a channel access time necessary for accomplishing a desired throughput with respect to the or each one of a plurality of data flows stored in a buffer corresponding to a priority queue; and setting as a common channel access time for transmitting the data flow associated with the priority queue the largest value of the calculated channel access times.

According to the forth aspect of the present invention, there is provided an access point having a channel access function based on an enhanced distributed channel access (EDCA) specified in an IEEE 802.11e standard, wherein calculating a channel access time necessary for accomplishing a desired throughput with respect to the or each one of a plurality of data flows stored in a buffer corresponding to an access category defined by the EDCA, and setting as a value of a TXOP Limit defined by the standard for the access category the largest value of the calculated channel access times.

Preferably the access point provided by the forth aspect of the present invention calculates the channel access time for each one of the plurality of data flows having different destinations and/or applications each other. Preferably it re-calculates the TXOP Limit value at predetermined time intervals. Preferably it calculates the TXOP Limit value with respect to the access category specified by a wireless transceiver for wirelessly communicating with the access point. A value of the desired throughput may be specified by a wireless transceiver for wirelessly communicating with the access point.

According to the fifth aspect of the present invention, there is provided a circuit module for a medium access control (MAC) layer having a channel access function based on an enhanced distributed channel access (EDCA) specified in an IEEE802.11e standard, wherein calculating a channel access time necessary for accomplishing a desired throughput with respect to the or each one of a plurality of data flows stored in a buffer corresponding to an access category defined by the EDCA, and setting as a value of a TXOP Limit defined by the standard for the access category the largest value of the calculated channel access times.

According to the sixth aspect of the present invention, there is provided, in channel access based on an enhanced distributed channel access (EDCA) specified in an IEEE802.11e standard, a method for an access point to set a TXOP Limit value defined by the standard comprising: calculating a channel access time necessary for accomplishing a desired throughput with respect to the or each one of a plurality of data flows stored in a buffer corresponding to an access category defined by the EDCA; and setting as the TXOP Limit value for the access category the largest value of the calculated channel access times.

### BRIEF DESCRIPTION OF THE DRAWINGS

FIG. 1 is a figure to explain the first embodiment of the present invention.

FIG. 2 is a figure to explain outline of transmission processes of the present invention.

FIG. 3 is a flow chart to explain how the TXOP limit value is decided in the present invention.

### DETAILED DESCRIPTION OF THE PREFERRED EMBODIMENTS

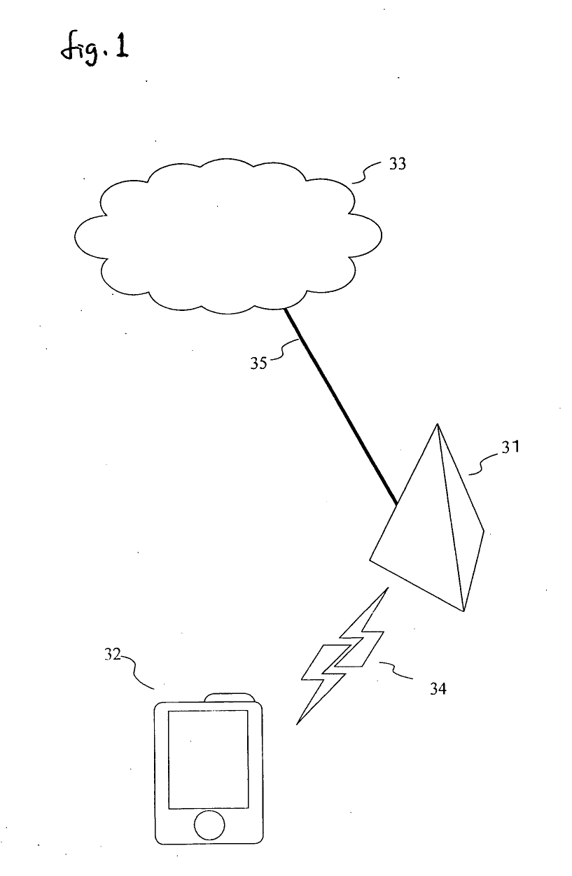

In the following a preferred embodiment of the present invention will be explained with reference to the drawings. FIG. 1 is a figure to explain a situation in which the present invention is applied. 31 denote an access point (AP) provided by the present invention, 32 denote a station (STA), and 33 denote an upper network connected with the AP 31. The AP 31 communicates with the STA 32 through wireless medium 34 based on IEEE802.11e standard. The AP 31 is connected with the upper network 33 by a wired line 35, and acts as a communication hub for the STA 32 to connect to the upper network 33.

The access point 31 and the station 32 has QoS facilities specified in IEEE802.11e standard, thus they can be called as a QoS-enhanced access point (QAP) and a QoS-enhanced station (QSTA) respectively. The QAP 31 and the QSTA 32 comprises two channel access functions, one is called as enhanced distributed channel access (EDCA), and the other is called as controlled channel access, referred to as HCF controlled channel access (HCCA). Both are specified in IEEE802.11e standard. The QAP 31 comprises Hybrid Controller (HC) specified in IEEE802.11e standard.

To support prioritized frame transmission, four access categories (ACs) are defined in EDCA. They are name as Voice, Video, Best Effort, and Background. Voice has the highest priority, Video is the second, Best Effort is the third, and Background has the lowest priority. Each of the ACs has its own buffer, and generally this buffer is called queue. Data arrived at MAC service access point (MAC_SAP) are classified to the appropriate access categories and stored to the correspondent buffer.

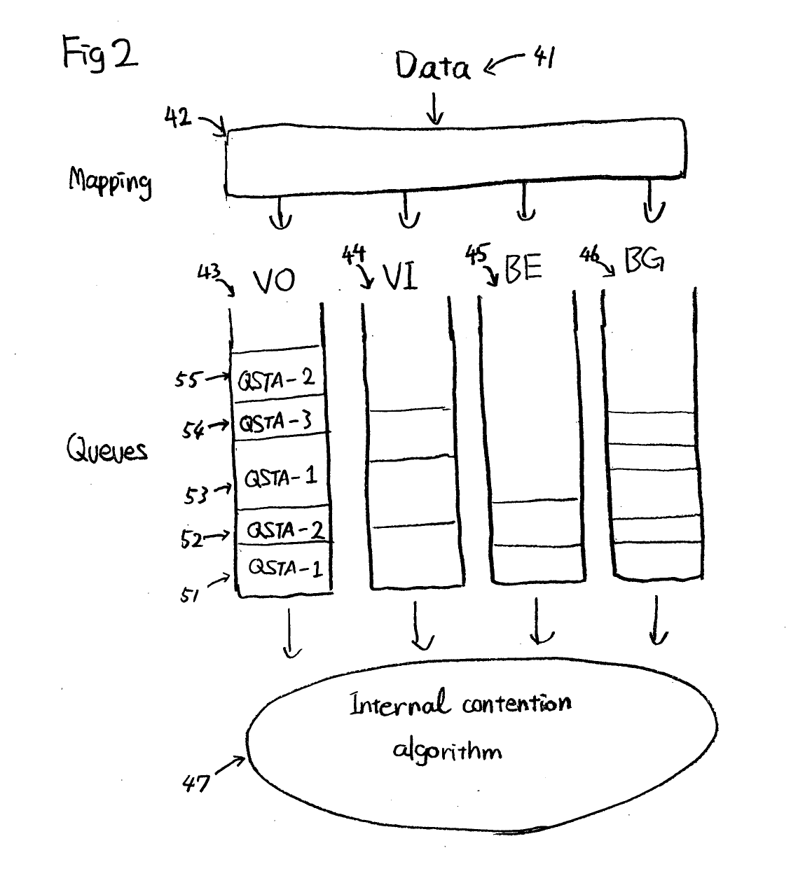

FIG. 2 schematically illustrates the processing of transmitting data at QAP 31. The data 41 conveyed from the upper network 33 to the QAP 31 are mapped into the appropriate AC at the MAC_SAP 42 installed in the QAP 31. The mapped data are stored in one of the appropriate queue; Voice_queue 43, Video_queue 44, Best_Effort_queue 45, or Background_queue 46. Then the internal contention algorithm 47 calculates the backoff for each AC based on the AIFSN (arbitration inter frame space number) and CW (contention window) in the EDCA parameter. The AC of which backoff counter becomes zero wins the internal contention. The winning AC then needs to contend externally for the wireless medium. The AC winning the external contention will obtain a transmission opportunity (TXOP), and be able to start transmission at the end.

Each of the queues may store one or plural data frames having different destinations or applications. The data frames having a same destination and application are called as a data flow, a traffic flow, or a traffic stream (TS). For example, the FIG. 2 is illustrating that, in the Voice_queue 43 the data frame 51 and the data frame 53 are data frames to be transmitted to the QSTA-1 (not illustrated), the data frame 52 and the data frame 55 are data frames to be transmitted to the QSTA-2 (not illustrated), and data frame 54 is a data frame to be transmitted to the QSTA-3 (not illustrated). And if the application of the data frame 51 and the data frame 53, they are called to belong to a same data flow, traffic flow or traffic stream. This is the same for the data frame 52 and the data frame 55. Sometimes the data flow etc can indicate just one data frame.

When a QSTA desires guarantee on the throughput of communication, that is, the QSTA needs a certain QoS, Admission Control procedure will be required. Admission control may be required in any traffic direction (uplink, downlink, direct, or bidirectional). In IEEE802.11e standard, the HC, which is in the QAP, is used to administer admission control in the network.

To realize the desired throughput, the QSTA need to be ensured an enough channel access time. In IEEE802.11e standard, the channel access time is related with TXOP Limit value. QAP 31 decides an appropriate TXOP Limit value which can maintain the required throughput and realize effective use of the wireless media, by the unique idea provided from the present invention.

When admission control is required, a QTSA transmits an ADDTS request frame which contains information of ACs that require admission control and information of desired throughput with regard to data flows.

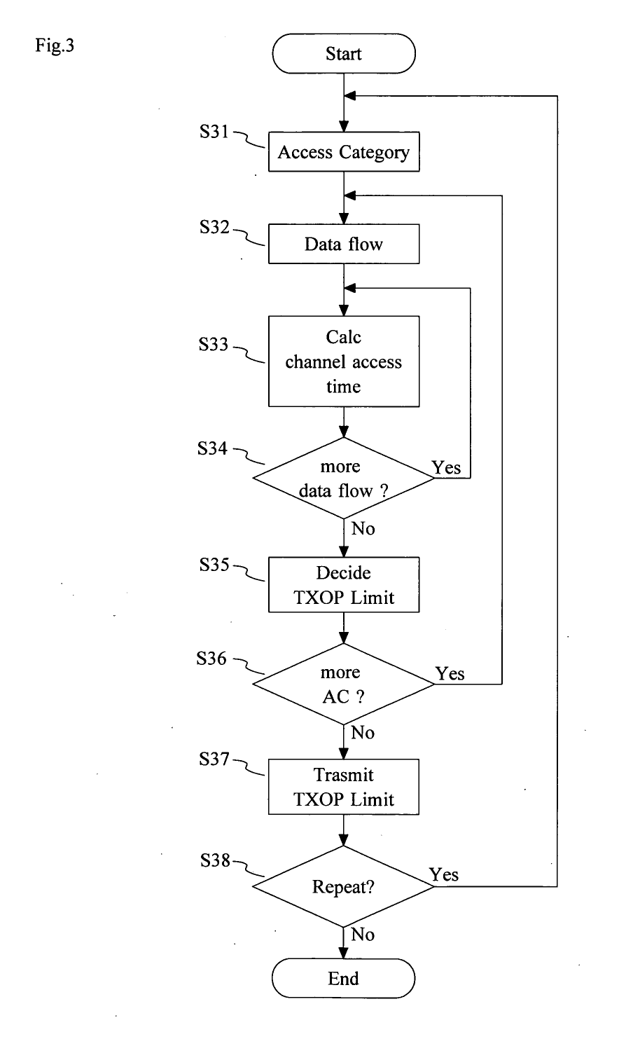

According to the present invention, the decisions of TXOP limit value are performed for each AC demanding admission control, and contains following steps. At first, calculating a channel access time realizing desired throughput for each data flow stored in the queue corresponding to the access category. And the next, deciding a TXOP Limit value as a maximum value among all calculated channel access time values and an initial value. These two steps are performed for each access category which requires admission control. In the following these steps will be explained with reference to FIG. 3.

FIG. 3 is a flowchart to explain how TXOP Limit values are decided by the present invention. Step S31 represents that the TXOP Limit values are decided for each access category which requires admission control. And step S32 represents that, for each access category, channel access values are calculated for each data stored in the queue corresponding to the access category. With reference to FIG. 2, as explained before, even the Voice_queue 43 stores five data flows denoted 51 to 55, there are only three data flows each of them having a different destination or a different application. Thus, the calculations of channel access time are performed only for these three data flows in the Voice_queue 43.

Back to FIG. 3, in step S33, calculation of a channel access time which realizes a desired throughput is performed. The ways of the calculating channel access time are not only one, however, when the QSTA transmitted desired throughput values to the QAP 31 in the ADDTS request, preferably the QAP 31 should take into account the transmitted throughput values in the calculation. An example of the calculation method will be explained later. In step S34, the QAP checks whether the queue contains another data flows for which the calculations are not finished yet. If yes, then step S33 will be repeated.

After finishing calculations of necessary channel access times for all data flows, the QAP 31 decides a TXOP Limit value of the access category as a maximum value among all calculated channel access time values and an initial value (step S35). In step S36, the QAP 31 checks whether there are another data access categories for which the TXOP Limit is not decided yet. If yes, goes back to step S32 and repeats the process again. If the QAP 31 finished the decision of TXOP Limit values for all access categories demanding admission control, the decided TXOP Limit values are advertise in a beacon frame (step S37). Preferably the TXOP limit values are updated in an appropriate interval.

Hereby preferable TXOP Limit values can be obtained for each access category, and it results the effective use of the wireless medium.

In the following an example of calculating channel access times in the above step S33 will be explained.

Without loss of generality, we assume that a QSTA has K priority queues with distinct QoS requirement.

Using renewal theory, throughput ρₖ[i] of traffic stream (data flow) i in a priority queue k (0≦k≦K−1) for one transmission cycle can be expressed as:

$${ρ}_{k} [ i ] = \frac{\overline{{L}_{k} [ i ]}}{\overline{{T}_{k} [ i ]}} \qquad ( 1 )$$

\overline{Lₖ[i]} is the average length of a frame in traffic stream i in the priority queue k. \overline{Tₖ[i]} denotes the average transmission cycle, which comprises \overline{T_{I}}, \overline{T_{C}} and \overline{T_{S}}. \overline{T_{I}} means idle periods in the priority queue k, \overline{T_{C}} means unsuccessful periods (due to collision and error), and \overline{T_{S}} means a successful period. They are expressed as the following equation.
   \overline{T_{C}}=\overline{CN}(τ+T_{SIFS}+AIFS[k]×δ+T_{RTS}) (2)
   \overline{T_{S}}=T_{RTS}+T_{CTS}+T_{ACK}+T_{DATA}+4τ+4T_{SIFS}+AIFS[k]×δ (3)
   \overline{T_{I}}=(\overline{CN}+1) {averaged_idle_time} (4)

Notations in these equations are given in Table 1.

TABLE 1
Notations for throughput calculation

| | | | |
|---|---|---|---|
| \overline{CN} | The averaged | τ | Propagation delay |
| | number of | | |
| | collisions | | |
| | (real and virtual | | |
| | collisions) | | |
| AIFS[k] | Arbitration | T_{SIFS} | The length of Short |
| | Interframe Space | | Interframe Space |
| | (AIFS) of the | | (SIFS) time |
| | priority queue k | | |
| δ | a length of a | T_{RTS} | Time to transmit a |
| | slot time | | RTS frame |
| T_{CTS} | Time to transmit | T_{ACK} | Time to transmit a |
| | a CTS frame | | ACK frame |
| T_{DATA} | Time to transmit | averaged_idle_time | Averaged length of |
| | an data frame | | idle time |

RTS, CTS, ACK, AIFS, and SIFS are specified in IEEE802.11 or IEEE802.11e.

From above equations, we find the throughput of the traffic stream i is degraded as the number of \overline{CN} increases.

Given a channel access time mₖ[i](seconds), the number of frames C which a QSTA can additionally transmit in the period is expressed in the equation (5).

$$⌊ \frac{{m}_{k} [ i ] - {\overline{T}}_{s}}{B} ⌋ = C \\ B = 2 {T}_{SIFS} + {T}_{DATA} + {T}_{ACK} \qquad ( 5 )$$

Now ρₖ[i] and \overline{T_{S}} can be further re-expressed as the following equation.

$${ρ}_{k} [ i ] = \frac{\overline{{L}_{k} [ i ]} ( 1 + C )}{\overline{{T}_{k} [ i ]}} , \\ \overline{{T}_{s}} = {T}_{RTS} + {T}_{CTS} + {T}_{ACK} + {T}_{DATA} ( 1 + C ) + 4 τ + 4 {T}_{SIFS} + \\ AIFS [ k ] \times δ + 2 C ( {T}_{SIFS} {T}_{ACK} + τ ) \qquad ( 6 )$$

In the embodiment, the throughput ρₖ[i] is requested from QSTA 32 or other QSTAs in ADDTS request for the traffic stream i in the access category k. ρₖ[i] may be the same for every i in the access category k.

By using equation (5) and (6), a required channel access time mₖ[i] to achieve the requested throughput ρₖ[i] for the traffic stream i in the priority queue (access category) k can be calculated. The above is an example of calculation in step S33 of FIG. 3. And among the calculated mₖ[i], (i=0,1,2, . . . ), the maximum mₖ[i] will be decided as the TXOP limit value of the access category k in step S35 of FIG. 3. An initial value of the TXOP limit may be also considered (for example, the TXOP limit value will be a maximum value among all the calculated mₖ[i] and a initial value.)

In the above a preferred embodiment of the present invention has been illustrated. However, it is to be understood that various substitutions and changes can be made by those who skilled in the art without departing from the spirit of the present invention. Because of the benefit of the present invention, it would be worthwhile to consider implementing the present invention in various QoS-required communications using contention-based channel access like IEEE802.11e standard. Thus the present invention can be implemented not only in the present IEEE802.11e but also in the future IEEE802.11 related standards.

Also, the present invention can be applied as a circuit module for MAC layer having a channel access function using a priority queuing, wherein calculating a channel access time necessary for accomplishing a desired throughput with respect to the or each one of a plurality of data flows stored in a buffer corresponding to a priority queue, and setting as a common channel access time for transmitting the data flow associated with the priority queue the largest value of the calculated channel access times. Such a circuit module will be beneficial for QoS-required communications using priority queuing and contention-based channel access like IEEE802.11e standard. An IEEE802.11e access point comprising a MAC circuit module provided by the present invention can utilize a superior algorithm provided by the present invention to deicide TXOP Limit values.

What is claimed is:

1. A wireless transceiver having a channel access function using priority queuing, wherein
calculating a channel access time necessary for accomplishing a desired throughput with respect to the or each one of a plurality of data flows stored in a buffer corresponding to a priority queue, and
setting as a common channel access time for transmitting the data flow associated with the priority queue the largest value of the calculated channel access times.

2. The wireless transceiver according to claim 1, wherein performing the channel access based on a contention-based channel access.

3. The wireless transceiver according to claim 1, wherein calculating the channel access time for each one of the plurality of data flows having different destinations and/or applications each other.

4. The wireless transceiver according to claim 1, wherein in order to allow an another wireless transceiver for wirelessly communicating with the wireless transceiver to comply with the common channel access time, transmitting the common channel access time to the another wireless transceiver.

5. The wireless transceiver according to claim 1, wherein calculating the common channel access time with respect to the priority queue specified by an another wireless transceiver for wirelessly communicating with the wireless transceiver.

6. The wireless transceiver according to claim 1, wherein a value of the desired throughput is specified by an another wireless transceiver for wirelessly communicating with the wireless transceiver.

7. The wireless transceiver according to claim 1, wherein re-calculating the common channel access time at predetermined time intervals.

8. The wireless transceiver according to claim 1, wherein the wireless transceiver comprises an access point for a wireless area network that complies with IEEE 802.11 and/or a derivative standard thereof.

9. The wireless transceiver according to claim 1 wherein the priority queuing is incorporated into the channel access function for a medium access control layer.

10. A circuit module for a medium access control (MAC) layer having a channel access function using a priority queuing, wherein
calculating a channel access time necessary for accomplishing a desired throughput with respect to the or each one of a plurality of data flows stored in a buffer corresponding to a priority queue, and
setting as a common channel access time for transmitting the data flow associated with the priority queue the largest value of the calculated channel access times.

11. A method for calculating a channel access time necessary for ensuring a desired throughput for a wireless transceiver for performing channel access using priority queuing system, the method comprising:
calculating a channel access time necessary for accomplishing a desired throughput with respect to the or each one of a plurality of data flows stored in a buffer corresponding to a priority queue; and
setting as a common channel access time for transmitting the data flow associated with the priority queue the largest value of the calculated channel access times.

12. An access point having a channel access function based on an enhanced distributed channel access (EDCA) specified in an IEEE 802.11e standard, wherein,
calculating a channel access time necessary for accomplishing a desired throughput with respect to the or each one of a plurality of data flows stored in a buffer corresponding to an access category defined by the EDCA, and,
setting as a value of a TXOP Limit defined by the standard for the access category the largest value of the calculated channel access times.

13. The access point according to claim 12, wherein calculating the channel access time for each one of the plurality of data flows having different destinations and/or applications each other.

14. The access point according to claim 12, wherein re-calculating the TXOP Limit value at predetermined time intervals.

15. The access point according to claim 12, wherein calculating the TXOP Limit value with respect to the access category specified by a wireless transceiver for wirelessly communicating with the access point.

16. The access point according to claim 12, wherein a value of the desired throughput is specified by a wireless transceiver for wirelessly communicating with the access point.

17. The access point according to claim 12, wherein the channel access time is calculated according to a following equation:
$$⌊ \frac{{m}_{k} [ i ] - \overline{{T}_{S}}}{B} ⌋ = C$$
where mₖ[i] denotes a channel access time that corresponds to an i-th one of the data flows stored in the buffers that corresponds to a k-th one of the access categories, and,
$$B = 2 {T}_{SIFS} + {T}_{DATA} + {T}_{ACK} , \\ C = \frac{{ρ}_{k} [ i ] \cdot \overline{{T}_{k} [ i ]}}{\overline{{L}_{k} [ i ]}} - 1 , \\ \overline{{T}_{s}} = {T}_{RTS} + {T}_{CTS} + {T}_{ACK} + {T}_{DATA} ( 1 + C ) + 4 τ + 4 {T}_{SIFS} + \\ AIFS [ k ] \times δ + 2 C ( {T}_{SIFS} + {T}_{ACK} + τ ) ,$$
ρₖ[i] denotes a specified throughput for the data flow [i] in the access category [k] by a station,
\overline{Tₖ[i]} denotes an average transmission cycle of the data flow [i] in the access category [k],
\overline{Lₖ[i]} denotes an average length of frames in the data flow [i] in the access category [k],
T_{RTS} denotes a time to transmit a request-to-send (RTS) frame,
T_{CTS} denotes a time to transmit a clear-to-send (CTS) frame,
T_{ACK} denotes a time to transmit an acknowledgement (ACK) frame,
T_{DATA} denotes a time to transmit a data frame,
T_{SIFS} denotes a length of short interframe space (SIFS) time,
AIFS[k] denotes an arbitration interframe space (AIFS) of the access category [k],
τ denotes a propagation delay, and
δ denotes a length of a slot time.

18. A circuit module for a medium access control (MAC) layer having a channel access function based on an enhanced distributed channel access (EDCA) specified in an IEEE802.11e standard, wherein
calculating a channel access time necessary for accomplishing a desired throughput with respect to the or each one of a plurality of data flows stored in a buffer corresponding to an access category defined by the EDCA, and
setting as a value of a TXOP Limit defined by the standard for the access category the largest value of the calculated channel access times.

19. In channel access based on an enhanced distributed channel access (EDCA) specified in an IEEE802.11e standard, a method for an access point to set a TXOP Limit value defined by the standard comprising:
calculating a channel access time necessary for accomplishing a desired throughput with respect to the or each one of a plurality of data flows stored in a buffer corresponding to an access category defined by the EDCA, and
setting as the TXOP Limit value for the access category the largest value of the calculated channel access times.
